(19) United States
(12) Patent Application Publication
(10) Pub. No.: US 2008/0068565 A1
(43) Pub. Date: Mar. 20, 2008

(54) Micro display device

(75) Inventor: Deok Yong Ko, Seoul (KR)

Correspondence Address: PARK LAW FIRM, 3255 WILSHIRE BLVD, SUITE 1110, LOS ANGELES, CA, 90010, US

(73) Assignee: ODS CO., LTD.

(21) Appl. No.: 11/519,348

(22) Filed: Sep. 12, 2006

(51) Int. Cl. G03B 21/14

(52) U.S. Cl. 353/100

(57) ABSTRACT

Provided is a micro display device. The device includes a controller for controlling a whole operation; an interface for receiving an image signal; a micro display for receiving the image signal from the interface; and an optical system for receiving the image signal from the micro display, and magnifying the received image signal. The micro display is provided in a position not consistent with an optical axis, at an upper side or a lower side of the optical axis of the optical system. The optical system includes a lens only partially provided by half or more with respect to the optical axis, in front of the micro display; and a mirror only partially provided by half or more corresponding to an opposite side of the lens with respect to the optical axis.

### BACKGROUND OF THE INVENTION

1. Field of the Invention

The present invention relates to a display device, and more particularly, to a micro display device for magnifying an image outputted from a micro display.

2. Description of the Related Art

In order to conform to information age under rapid development, a requirement for an electronic display device essential to transmitting a large amount of information, for displaying video image, graphic, character, numeric, and a variety of data is being suddenly increased. A display device is being used in widespread fields of a home television, a notebook computer, an optical meter, a variety of panels of an industrial control device, and traffic, air, space, military fields. In recent years, even a three-dimensional video TV for vividly delivering not only senses of reality and presence but also human emotion appears, and new technologies are being continuously developed. The research for a new display device having a large sized screen of several meters as well as a lightweight, a small volume, and an excellent resolution is being required.

A display device for a personal mobile communication terminal in use mostly uses a two to three inch-class liquid crystal display (LCD) element. Thus, there is a limitation in displaying a graphic and a full size picture since an amount of information processing is much less and limited, a picture quality is bad, and the extent is that only character information is embodied. Methods up to now have a little difficulty in displaying a large amount of information and a high-definition picture using a small sized display device. Thus, it is required to embody a virtual screen for obtaining a substantial image effect. One example thereof can be a micro display device.

The micro display device refers to a device for magnifying an image of one inch or less outputted from a display into a large image, and outputting the magnified image. The micro display device is classified as a virtual micro display device and a projection micro display device.

The virtual micro display device magnifies and outputs an image using an optical system. The image is seen to be within a viewfinder, and a virtual image is different from a real image. A user who sees a screen through the viewfinder can view only the magnified image without viewing an original image. In other words, the virtual micro display device allows the user not to directly see the screen but to view the magnified image using the optical system.

In general, the virtual micro display device includes a micro display; a lens for magnifying the image outputted from the micro display; and a mirror for providing the user with the image magnified by and outputted from the lens. However, the conventional virtual micro display device magnifies the image outputted from the micro display, using a whole of the lens and the mirror, and thus is difficult to be miniaturized.

In other words, it is general that the micro display device is mainly applied to a portable terminal (mobile communication terminal, and digital multimedia broadcasting (DMB) phone). Being magnified using the lens, the image outputted from the micro display does not have to be magnified over the whole of the lens in view of an application characteristic of the micro display. However, at present, the whole of the lens is used and thus, there is a disadvantage that since an overall length of the optical system increases, a size of the micro display device increases in appearance.

### SUMMARY OF THE INVENTION

Accordingly, the present invention is directed to a micro display device that substantially overcomes one or more of the limitations and disadvantages of the conventional art.

One object of the present invention is to provide a micro display device only partially employing a lens and a mirror by half or more with respect to an optical axis, thereby reducing an overall length of an optical system.

Another object of the present invention is to provide a micro display device miniaturized by reducing an overall length of an optical system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a micro display device. The device includes a controller for controlling a whole operation; an interface for receiving an image signal; a micro display for receiving the image from the interface; and an optical system for receiving the image signal from the micro display, and magnifying the received image. The micro display is provided in a position not consistent with an optical axis, at an upper side or a lower side of the optical axis of the optical system. The optical system includes a lens only partially provided by half or more with respect to the optical axis, in front of the micro display so as to magnify the image outputted from the micro display; and a mirror only partially provided by half or more corresponding to an opposite side of the lens with respect to the optical axis so as to reflect the image exiting from the lens.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a block diagram illustrating a micro display device according to an exemplary embodiment of the present invention;

FIG. 2 illustrates an example of a detailed optical system shown in FIG. 1;

FIG. 3 illustrates another example of a detailed optical system shown in FIG. 1;

FIGS. 4A and 4B illustrate a display principle of an optical system according to the present invention;

FIGS. 5 and 6 illustrate application examples of a micro display device according to the present invention; and

FIGS. 7 to 9 illustrate housing structures of a micro display device according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

In the following description, a micro display device refers to a virtual micro display device for magnifying an image outputted from a micro display using an optical system.

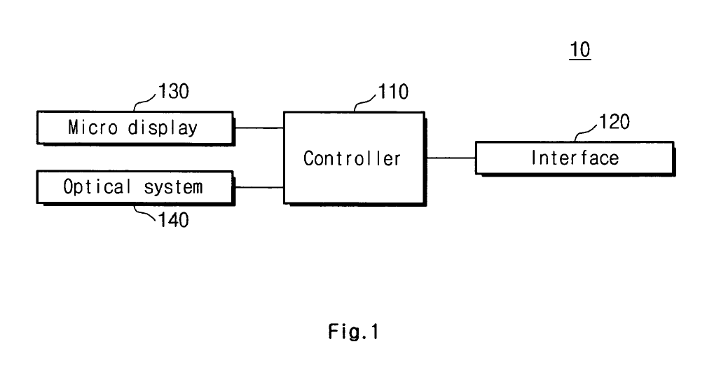

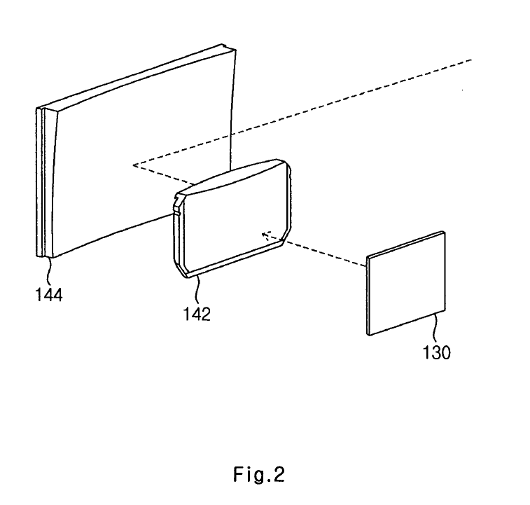

FIG. 1 is a block diagram illustrating the micro display device according to an exemplary embodiment of the present invention.

As shown in FIG. 1, the inventive micro display device 10 includes a controller 110 for controlling a whole operation; an interface 120 for receiving an image; a micro display 130 for receiving the image from the interface 120 and outputting the received image under the control of the controller 110; and an optical system 140 for magnifying an image outputted from the micro display 130.

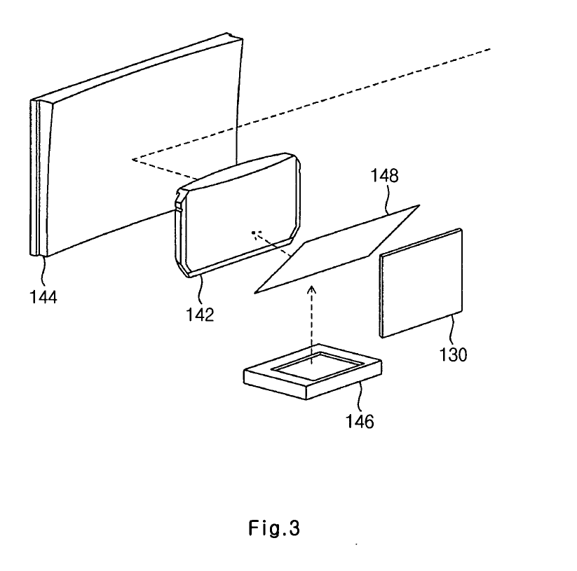

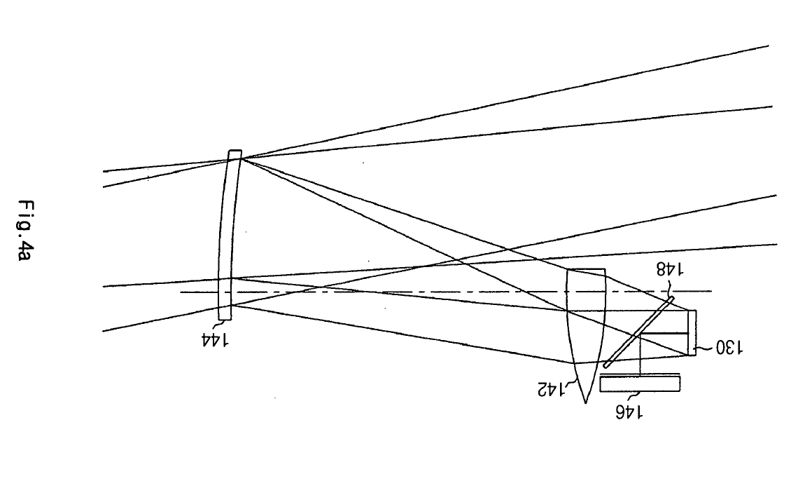

FIG. 2 illustrates an example of the detailed optical system shown in FIG. 1.

In the present invention, in order to miniaturize an overall length of the optical system and thus, resultantly miniaturize the micro display device, a lens 142 and a mirror 144 are only partially used by half or more with respect to an optical axis. The lens 142 is disposed in front of the micro display 130, and the mirror 144 is disposed in asymmetry with the lens 142. In the following description, the lens 142 refers to a lens only partially used by half or more with respect to the optical axis. The mirror 144 refers to a mirror only partially used by half or more with respect to the optical axis.

Referring to FIG. 2, the optical system 140 according to the present invention includes the lens 142 for magnifying the image outputted from the micro display 130; and the mirror 144 serving as a viewfinder for a user, generating a virtual image by the image magnified by the lens 142, and providing the generated virtual image to the user. An illumination unit is installed in rear or front of the micro display 130, and operates as a light source of the micro display 130. The illumination unit is not shown in FIG. 2.

In a more detailed description, the micro display 130 is provided in a position not consistent with the optical axis, at an upper side or a lower side of the optical axis of the lens 142 and the mirror 144. The lens 142 is disposed in front of the micro display 130 such that it is only partially provided by half or more with respect to the optical axis to magnify the image outputted from the micro display 130. The mirror 144 is disposed such that it is only partially provided corresponding to an opposite side of the lens 142 by half or more with respect to the optical axis, to more magnify the image magnified by the lens 142 and generate the virtual image.

In the micro display device having an asymmetric construction, the user sees the mirror 144 to observe the image, and observes the virtual image generated distant away by a designated distance at a rear side of the mirror 144.

In an exemplary embodiment of the present invention, the lens 142 forms the virtual image based on the image outputted from the micro display 130. The lens 142 can be constructed to have a distortion of a designated magnitude to correct a curved surface in a visible region (a region where the virtual image is focused) and an aberration of the mirror 144.

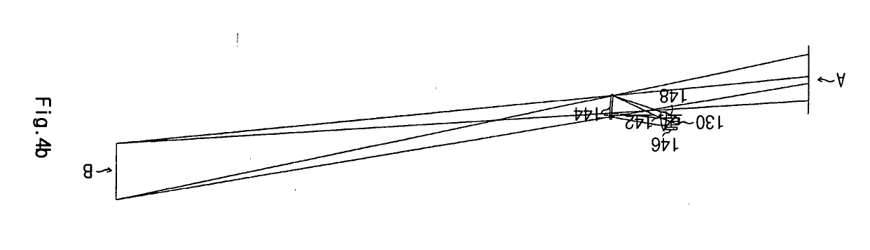

FIG. 3 illustrates another example of the detailed optical system shown in FIG. 1.

Further to the optical system of FIG. 2, the optical system of FIG. 3 includes an illumination unit 146 provided in rear or front of the micro display 130, and serving as a light source of the micro display 130; and a polarization film 148 for providing a reflection effect of the image outputted from the micro display 130.

In case where the optical system 140 is constructed as in this embodiment, the user can observe the image with more definition.

FIGS. 4A and 4B illustrate a display principle of the optical system according to the present invention.

Referring to FIG. 4A, the image outputted from the micro display 130 provides the reflection effect by the polarization film 148 and then, is incident on the lens 142 and is magnified by and outputted from the lens 142. The image magnified and outputted from the lens 142 is reflected by the mirror 144 and observed by the user.

As shown in FIG. 4B, the user sees the mirror 144 to observe the image at an observation side (A), and observes the magnified image(B) that varies in magnitude with a focal distance of the mirror 144 and a distance between the user and the mirror 144. The image observed by the user is a virtual image created by the mirror 144.

In the above micro display device, the micro display 130 is disposed in a position not consistent with the optical axis, thereby preventing the generation of a shadow region in the virtual image observed by the user.

In an exemplary embodiment of the present invention, the micro display 130 can be embodied by any one of emissive, transmissive, and reflective display devices. In the case of the emissive display device, the micro display 130 can be constructed using an organic electro luminescent (EL) or inorganic EL display. In the case of the transmissive display device, it can be constructed using a liquid crystal display (LCD). In the case of the reflective display device, it can be constructed using any one of digital light processing (DLP) and liquid crystal on silicon (LCOS). In the case of using the LCOS, it is desirable to use the polarization film for providing the effective reflection effect. Together, in the case of the transmissive display device, it is desirable that an illumination unit is further provided in rear of the micro display 130. In the case of the reflective display device, it is desirable that an illumination unit is further provided in front of the micro display 130.

The micro display 130 can be embodied to have a size of about 0.4 inch to 1.5 inch. A distance from the micro display 130 to the mirror 144, that is, the overall length can be approximately 80 mm to 150 mm. In this case, the virtual image has about 10 to 18 times, preferably 14 times of a size of the micro display 130. It can be differentiated depending on a kind of an object to be displayed, but it is desirable to control the virtual image by 12 inch.

It is desirable that the lens 142 is comprised of a convex lens, and the mirror 144 is comprised of a concave mirror.

The micro display device 10 according to the present invention can be constructed in a housing structure. In other words, the micro display device 10 can be constructed to be housed in a hexahedral box with a cover, and, according to need, expose the optical system, thereby allowing the user to view a desired image. In this case, it is desirable to control a housing box housing the micro display device 10 to have a depth of about 30 mm to 40 mm, and have a length (overall length) of about 80 mm to 150 mm. Such a housing structure can be based on various methods, and its detailed description will be made later.

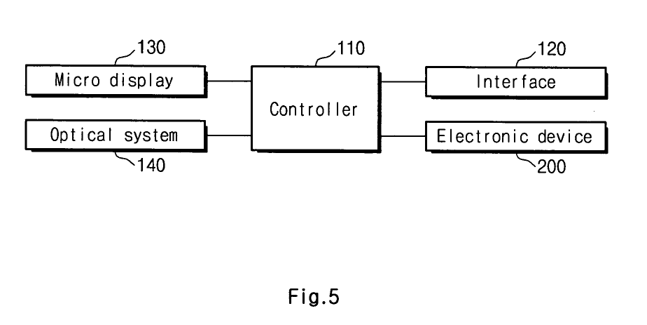

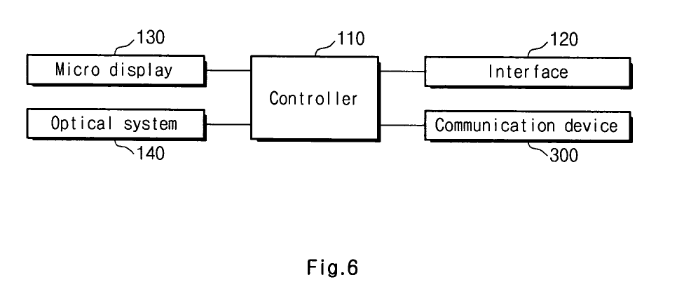

FIGS. 5 and 6 illustrate application examples of the micro display device according to the present invention.

FIG. 5 illustrate a case where the inventive micro display device 10 is applied to an electronic device having the image as an output signal, such as a television (TV), a desktop computer, and a notebook computer. FIG. 6 illustrates a case where the inventive micro display device 10 is applied to a communication device 300 such as a cellular phone, personal communications services (PCS), portable digital assistants (PDA), and a digital multimedia broadcasting (DMB) phone.

As shown in FIGS. 5 and 6, in case where the micro display device 10 is applied to the electronic device 200 or the communication device 300, a display unit of the electronic device 200 or the communication device 300 is miniaturized and built in as the micro display. The user sees the mirror as the viewfinder, thereby observing the magnified image.

The above application of the micro display device to various devices can be drawn to the user's convenient use of various multimedia services, such as a common use of DMB and watching on TV or viewing a movie while moving, and thus the improvement of a percentage of service use. Also, the inventive micro display device has an advantage that since the overall length is minimized using the lens and the mirror, whole equipment can be more miniaturized while providing a large screen, thereby making a carriage more convenient.

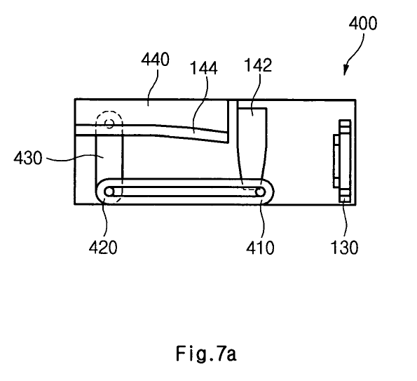

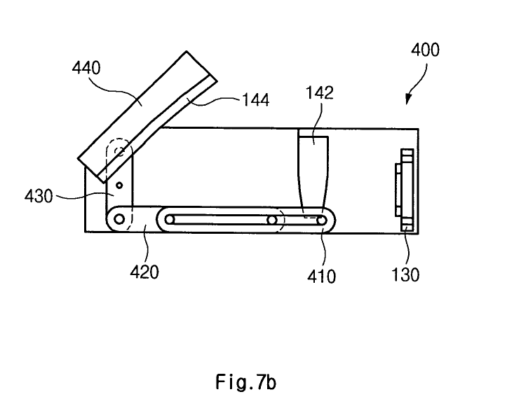

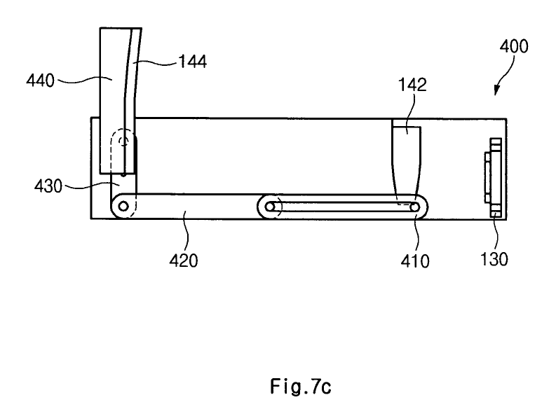

FIGS. 7 to 9 illustrate housing structures of the micro display device according to the present invention.

FIGS. 7A to 7C illustrate the housing structure of the micro display device according to an exemplary embodiment of the present invention. As shown, the housing structure includes a main body 400 having a housing space, and having the micro display 130 fixed and provided at one side of an inner part thereof; a first link 410 distant away by a designated distance from the micro display 130 and provided at an inner and bottom surface of the main body 400, and having the lens 142 only partially fixed and provided by half or more with respect to the optical axis at an end side of the micro display 130; a second link 420 connecting to an end of the first link 410 where the lens 142 is not provided; a third link 430 vertically provided at an end of the second link 420 not connecting with the first link 410; and a mirror fixing plate 440 rotatably provided by a hinge at an end of the third link 430 not connecting with the second link 420, and having the mirror 144 only partially attached therein by half or more with respect to the optical axis. The mirror fixing plate 440 has a structure in which it is horizontal with a bottom surface of the main body 400 in its closed state, and is rotatable by 90° toward an upper side of the main body 400. The mirror fixing plate 440 has a joint structure in which it can be fixed to the third link 430 so that it can keep an upright state when being rotated up by 90° and opened.

The first link 410 can further include a sliding groove 412. It is desirable that the first link 410 is constructed to allow the second link 410 to be left/right slidable along the sliding groove 412. In this case, an optical distance between the lens 142 and the mirror 144 can be controlled, thereby controlling a magnitude of the outputted image. At the time of housing, the first link 410 can be combined with the second link 420 by the sliding groove 412, thereby achieving miniaturization.

FIG. 7B illustrates an in-process state where the second link 420 is slid from the first link 410 to the left and the mirror fixing plate 40 is rotated and opened to the exterior, to use the micro display device. FIG. 7C illustrates a state where the second link 420 is completely slid from the first link 410, the mirror fixing plate 440 is completely opened, and the mirror 144 is vertically fixed at an opposite side of the optical axis of the lens 142.

Though not illustrated, the micro display 130 can connect with the interface 120 through the controller 110, and can connect with various electronic devices and communication devices through the interface 120.

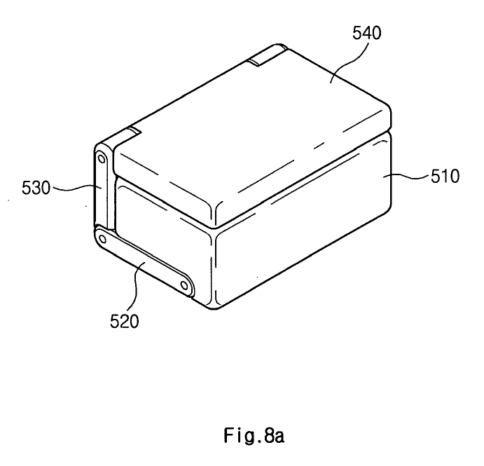

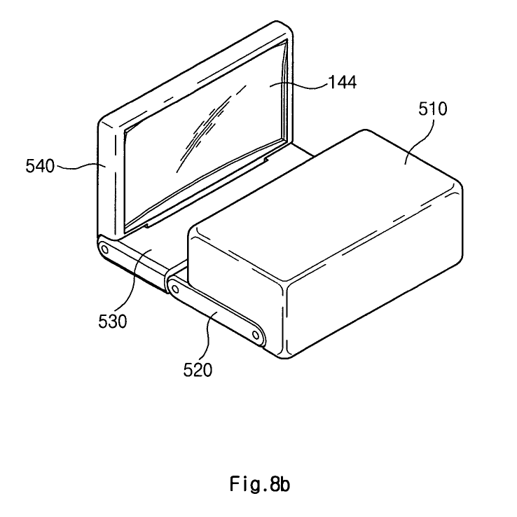

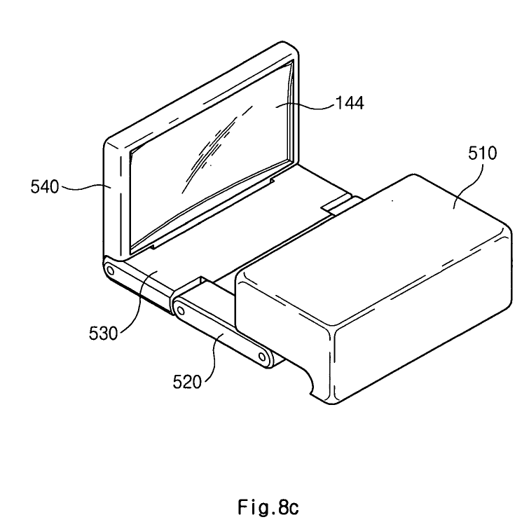

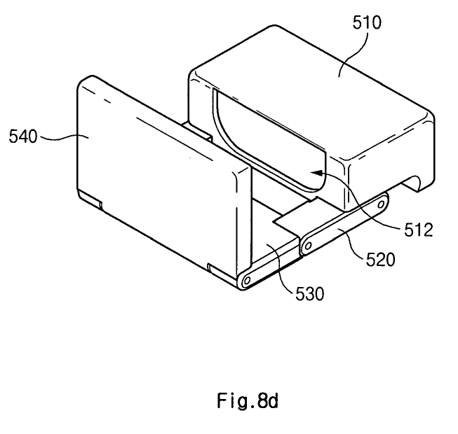

FIGS. 8A to 8D illustrate the housing structure of the micro display device according to another exemplary embodiment of the present invention.

As shown, the housing structure includes a housing box 510 opened at its one side (FIG. 8D), and having a micro display (not shown) fixed and provided at one side of an inner part facing an opening part 512, and having a lens (not shown) only partially provided by half or more with respect to an optical axis in front of the micro display; links 520 provided at left and right sides of a lower part of the housing box 510 centering on the opening part 512 of the housing box 510; an auxiliary plate 530 connecting to the links 520, which are provided at ends of opening part 512 sides of the housing box 510, and rotatably provided by a hinge at the link 520 to open and close the opening part 512; and a mirror fixing plate 540 rotatably provided at the auxiliary plate 530, and covering an upper part of the housing box 510. The housing box 510 and the link 520 can be provided to be left/right slid. A mirror 144 is only partially attached by half or more corresponding to an opposite side of the lens with respect to the optical axis, inside the mirror fixing plate 540.

In the above housing structure of the micro display device, FIG. 8B illustrates a state where the mirror fixing plate 540 having the mirror 144 fixed and attached thereto and the auxiliary plate 530 are opened outside, and FIG. 8C illustrates a state where the housing box 510 is slid from the link 520 to the right.

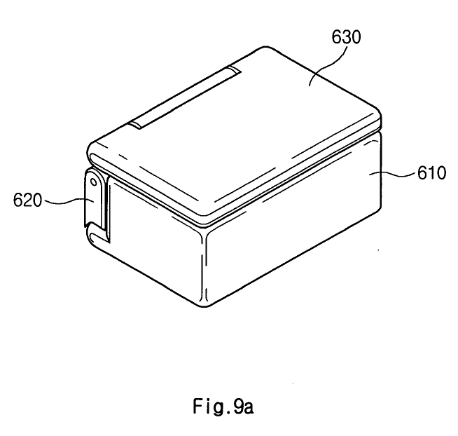

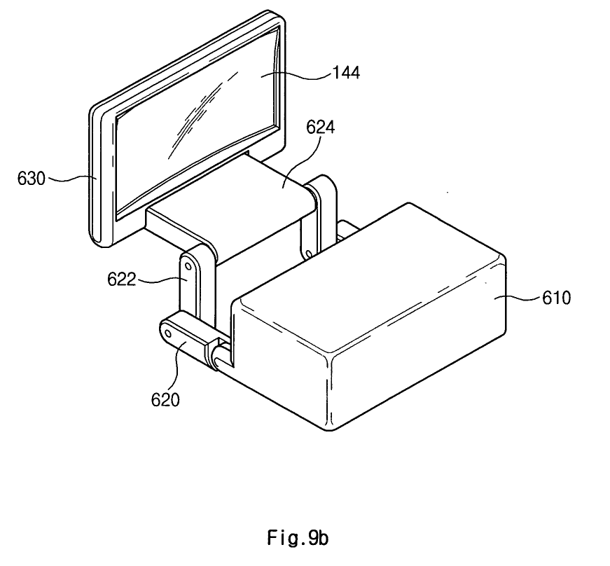

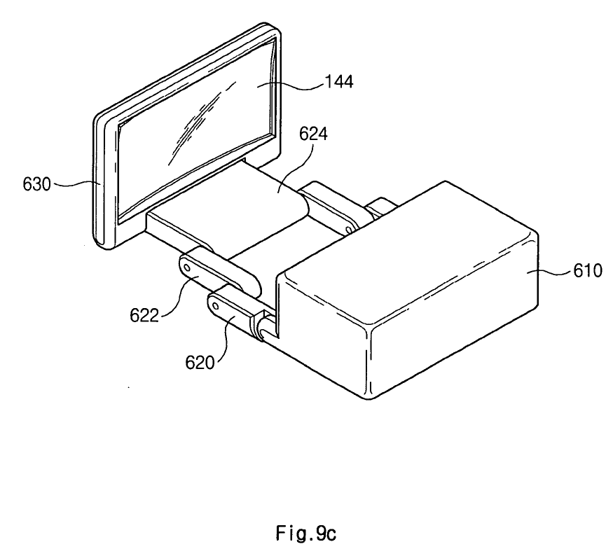

FIGS. 9A to 9C illustrate the housing structure of the micro display device according to a further another exemplary embodiment of the present invention.

As shown, the housing structure according to this embodiment of the present invention includes a housing box 610 opened at its one side, and having a micro display (not shown) fixed and provided at one side of an inner part facing an opening part, and having a lens (not shown) only partially provided by half or more with respect to an optical axis in front of the micro display; first links 620 provided at left and right sides of the opening part of the housing box 610, to rotate about the housing box 610 by a hinge; second links 622 provided at the other sides of the first links 620 not connecting with the housing box 610, to rotate with the first links 620 by a hinge; an auxiliary plate 624 provided at the other sides of the second links 622 not connecting with the first link 620, to rotate by a hinge, and opening and closing the opening part of the housing box 610; and a mirror fixing plate 630 vertically provided at the other end of the auxiliary plate 624, and having a mirror 144 only partially fixed and attached inside by half or more corresponding to an opposite side of the lens with respect to an optical axis.

In the above housing structure of the micro display device, FIG. 9B illustrates a state where the mirror fixing plate 630 having the mirror 144 fixed and attached thereto and the auxiliary plate 624 are opened outside by the first links 620 and the second links 622, and FIG. 9C illustrates a state where the first links 620, the second links 622, the auxiliary plate 624, and the mirror fixing plate 630 are completely unfolded.

As described above with reference to FIGS. 7 to 9, the inventive micro display device has an advantage that it can be embodied in the housing structure and thus, can be more miniaturized, thereby facilitating a movement, and making a carriage convenient.

According to the present invention, the lens and the mirror can be only partially used by half or more with respect to the optical axis, thereby miniaturizing the micro display device. Thus, in case where the micro display device is applied to the communication device, it can be housed without increasing a volume of the communication device, and the user can carry the communication device while using various multimedia services through the large screen.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A micro display device comprising:
a controller for controlling a whole operation;
an interface for receiving an image signal;
a micro display for receiving the image signal from the interface; and
an optical system for receiving the image from the micro display, and magnifying the received image,
wherein the micro display is provided in a position not consistent with an optical axis, at an upper side or a lower side of the optical axis of the optical system, and
wherein the optical system comprises a lens only partially provided by half or more with respect to the optical axis, in front of the micro display so as to magnify the image outputted from the micro display; and a mirror only partially provided by half or more corresponding to an opposite side of the lens with respect to the optical axis so as to reflect the signal exiting from the lens.

2. The device according to claim 1, wherein the micro display is an emissive, transmissive, or reflective display.

3. The device according to claim 2, wherein in the case of the emissive display, the micro display is constructed using an organic EL (electro luminescent) display or an inorganic EL display.

4. The device according to claim 2, wherein in the case of the transmissive display, the micro display is constructed using a LCD (liquid crystal display).

5. The device according to claim 4, wherein the optical system further comprises an illumination unit provided in rear of the micro display.

6. The device according to claim 2, wherein in the case of the reflective display, the micro display is constructed using DLP (digital light processing) or LCOS (liquid crystal on silicon).

7. The device according to claim 6, wherein the optical system further comprises an illumination unit provided in front of the micro display.

8. The device according to claim 1, wherein the micro display has a size of about 0.45 inch to 1.5 inch.

9. The device according to claim 1, wherein the optical system has an overall length of about 80 mm to 130 mm.

10. The device according to claim 1, wherein a virtual image formed by the optical system has about 12 to 18 times of a size of the micro display.

11. The device according to claim 1, being constructed by a structure in which it can be housed in a hexahedral box with a cover.

12. A micro display device comprising:
a main body having a housing space, and having a micro display, which connects to a controller, fixed and provided at one side of an inner part thereof;
a first link distant away by a designated distance from the micro display and provided at an inner and bottom surface of the main body, and having a lens only partially fixed and provided by half or more with respect to an optical axis at an end side of the micro display;
a second link connecting to an end of the first link where the lens is not provided;
a third link vertically provided at an end of the second link not connecting with the first link; and
a mirror fixing plate rotatably provided at an end of the third link not connecting with the second link, and having a mirror, which corresponds to an opposite side of the lens, only partially attached therein by half or more with respect to the optical axis,
wherein a controller connects with an interface.

13. The device according to claim 12, wherein the mirror fixing plate has a structure in which it is horizontal with a bottom surface of the main body in its closed state, and is fixed to the third link so that it can keep an upright state when being rotated up by 90° and opened.

14. The device according to claim 12, wherein the first link further comprises a sliding groove such that the second link is slid to the left and right along the sliding groove.

15. A micro display device comprising:
a housing box having an opening part at its one side, having a micro display, which connects with a controller, fixed and provided at one side of an inner part facing the opening part, and having a lens only partially provided by half or more with respect to an optical axis in front of the micro display;
links provided at left and right sides of a lower part of the housing box, centering on the opening part;
an auxiliary plate connecting to the links provided at ends of opening part sides, and rotatably provided at the links to open and close the opening part; and
a mirror fixing plate rotatably provided at the auxiliary plate to cover an upper part of the housing box, and having a mirror, which corresponds to an opposite side of the lens, only partially attached inside by half or more with respect to the optical axis,
wherein the controller connects with an interface.

16. The device according to claim 15, wherein the housing box is left/right slidable from the links.

17. The device according to claim 15, wherein the links comprise:
first links provided at left and right sides centering on the opening part, and rotating about the housing box; and
second links provided at the other sides of the first links not connecting with the housing box, and rotating about the first links.

18. The device according to claim 17, wherein the auxiliary plate is rotatably provided at the other sides of the second links not connecting with the first links, and opens and closes the opening part of the housing box.

19. The device according to claim 1, wherein the optical system further comprises a polarization film between the micro display and the lens.

20. The device according to claim 1, wherein the mirror has a concave surface for magnifying an image projected from the lens.
